(19) United States
(12) Patent Application Publication
(10) Pub. No.: US 2004/0139431 A1
(43) Pub. Date: Jul. 15, 2004

(54) Determining graduated availability for meetings by individuals and groups

(75) Inventor: Michael Muller, Medford, MA (US)

Correspondence Address: Steven M. Greenberg, CHRISTOPHER & WEISBERG, P.A., 200 East Las Olas Boulevard, Suite 2040, Fort Lauderdale, FL, 33301, US

(73) Assignee: International Business Machines Corporation, Armonk, NY

(21) Appl. No.: 10/331,389

(22) Filed: Dec. 30, 2002

(51) Int. Cl. G06F 9/46

(52) U.S. Cl. 718/100

(57) ABSTRACT

A method, system and apparatus for scheduling a task based upon a measure of graduated availability for a specified time frame. The method can include identifying tasks which previously had been scheduled about a specified time frame. Each of the identified tasks can be weighted according to a likelihood that a newly scheduled task when combined with the weighted identified tasks would interfere with completing the weighted identified tasks. An average of the weights can be computed, the average producing a graduated availability for the specified time frame. Finally, the graduated availability can be stored for use in scheduling a new task about the specified time frame. For example, a new task can be scheduled about the specified time frame only if the graduated availability indicates that the new task would not interfere with completing the weighted identified tasks.

### BACKGROUND OF THE INVENTION

1. Statement of the Technical Field

The present invention relates to the field of groupware and more particularly to calendaring a meeting according to the schedules of participants in the meeting.

2. Description of the Related Art

Conventional groupware includes among other important features, a group scheduling capability. Specifically, in conventional groupware, one user can schedule a meeting with one or more invited participants simply by proposing a time and date for the meeting. If the meeting itself, and more importantly, the proposed time and date for the meeting is acceptable to the invited participants, the invited participants can accept the proposed meeting and the groupware system can schedule the meeting in each of the respective calendars of the participants. Consequently, for each participant, their personal calendar will reflect the scheduled meeting at the accepted time and date.

Notably, many sophisticated groupware systems will automatically detect conflicts in the proposed time and date of a meeting. More particularly, where the user proposing the meeting selects a date and time which conflicts with another calendared or otherwise scheduled obligation of one or more of the invited participants, the groupware system can so notify the user of the conflict before the participants can be invited. As will be recognized by one skilled in the art, detecting a conflict simply can be a function of querying the respective tables of each participant and the user to detect a scheduled to-do, event or other task during the period proposed for the meeting.

In this regard, conventional groupware systems distinguish between a time frame which already has been allocated by a user, and a time frame which has yet to be allocated by a user. While logically it can be sensible to classify availability in a binary fashion where a user either can be “free” or “busy”, realistically, individual groupware system users can be sensitive to the number and nature of time commitments established for a range of time periods including ranges of time both within allocated time frames and also outside of, but proximate to, allocated time frames. In particular, some would become overloaded by scheduling too many tasks about a single period of time.

Yet, conventional groupware systems and personal information management systems remain indifferent to non-conflicting albeit proximate tasks associated with a particular time frame. Consequently, when attempting to schedule a meeting during a time frame which, though vacant, would prove problematic to one or more invited participants due to perceived overloading, unnecessary declinations can result. As a result, the coordinator of the meeting can be compelled to attempt multiple meeting requests for different time frames randomly until identifying a time frame deemed suitable to all invited participants. The process of haphazardly selecting a time frame for a proposed meeting, however, can be wasteful in terms of time and effort. Accordingly, there remains a long felt, unsolved need for a groupware system having a level of sensitivity towards overloading when proposing a scheduled task.

### SUMMARY OF THE INVENTION

The present invention addresses the foregoing deficiencies of conventional groupware systems and provides a novel and non-obvious solution to the problem of scheduling meetings among participants to the groupware system. A method for scheduling a task based upon a measure of graduated availability for a specified time frame can include identifying tasks which previously had been scheduled about a specified time frame. Each of the identified tasks can be weighted according to a likelihood that a newly scheduled task when combined with the weighted identified tasks would interfere with completing the weighted identified tasks. An average of the weights can be computed, the average producing a graduated availability for the specified time frame. Finally, the graduated availability can be stored for use in scheduling a new task about the specified time frame.

In this regard, it can be the circumstance where a user prefers to schedule tasks in a manner such that the user does not become overloaded with too many tasks scheduled for a specified time frame. To that end, the method can further include the step of scheduling a new task about the specified time frame only if the stored graduated availability indicates that the new task would not interfere with completing the weighted identified tasks. However, in an alternative circumstance, the user might prefer to schedule as many tasks during a specified time period as possible so as preserve or create significant blocks of free time outside of the specified time period. In this case, the method can further include the step of scheduling the new task about the specified time frame only if the stored graduated availability indicates that the new task would interfere with completing the weighted identified tasks.

In one aspect of the invention, a buffer zone can be established about the specified time frame. Consequently, the weighting step can be performed only for tasks identified as being scheduled within the buffer zone. Likewise, all other tasks scheduled outside both the specified time frame and the buffer zone can be ignored when performing the computing step. Also, tasks can be further identified which have been scheduled during the specified time frame. It can be determined whether these tasks directly conflict with the new task. If it is determined that a new task would directly conflict with these tasks, any request to schedule the new task during the specified time frame can be denied.

In a preferred aspect of the invention, the performing, identifying, weighting and computing steps can be performed for each of a set of specified time frames. Consequently, the new task can be scheduled about a selected one of the specified time frames which has a computed graduated availability indicating that the new task would least interfere with completing the weighted identified tasks when compared to computed graduated availabilities associated with others of the specified time frames. In this way, a set of specified time frames for a new task can be proposed knowing that the most optimal one of the specified time frames can be chosen for the new task.

In another preferred aspect of the invention, the identifying, weighting and computing steps can be performed for each of a set of invited participants in the new task, for each of a set of specified time frames. As a result, an average of computed graduated availabilities for the invited participants can be computed for each one of the specified time frames. In consequence, the new task can be scheduled about a selected one of the specified time frames which has a computed average of computed graduated availabilities indicating that the new task would least likely interfere with completing the weighted identified tasks among the invited participants when compared to computed averages of other computed graduated availabilities associated with others of the specified time frames.

A groupware system also can be provided in accordance with the inventive arrangements. The groupware system can include group calendering logic configured to schedule tasks for individual groupware users during specified time periods. A data store can be coupled to the group calendaring logic for storing calendars managed by the group calendaring logic for each of the users. Finally, a graduated availability processor can be coupled to the group calendaring logic and the data store. In particular, the graduated availability processor can be programmed to determine whether scheduling a new task in at least one of the stored calendars involving selected ones of the users during a specified time frame would overload any one of the selected ones of the users by virtue of other tasks which had previously been scheduled in proximity to, but not in direct conflict with, the specified time frame.

Notably, in the groupware system of the present invention, the tasks can include events, to-dos, and reminders. Consequently, in the groupware system of the present invention, a store of pre-configured weights can be provided which are accessible by the graduated availability processor for each different type of task which can be scheduled by the group calendaring logic. Thus, the graduated availability processor can apply the pre-configured weights when determining whether scheduling the new task would overload any one of the selected ones of the users.

### BRIEF DESCRIPTION OF THE DRAWINGS

There are shown in the drawings embodiments which are presently preferred, it being understood, however, that the invention is not limited to the precise arrangements and instrumentalities shown, wherein:

FIG. 1 is a schematic illustration of an exemplary groupware system configured to process requests to schedule a meeting according to the graduated availability of the invited participants; and,

FIG. 2 is a flow chart illustrating a process for scheduling a meeting according to the graduated availability of the invited participants.

### DETAILED DESCRIPTION OF THE PREFERRED EMBODIMENTS

The present invention is a method, system and apparatus for scheduling tasks for specific time frames in a personal information manager (PIM) according to the graduated availability associated with the specific time frames. In accordance with the inventive arrangements, a PIM task such as an event, to-do or reminder, can be provisionally scheduled for a specified time frame. Where a conflicting event cannot be identified based upon the specified time frame, non-conflicting tasks can be identified and weighted according to pre-specified values. The identified and weighted non-conflicting tasks can be averaged to produce the graduated availability for the specified time frame. Where the graduated availability is deemed non-satisfactory, a different time frame can be specified for the PIM task.

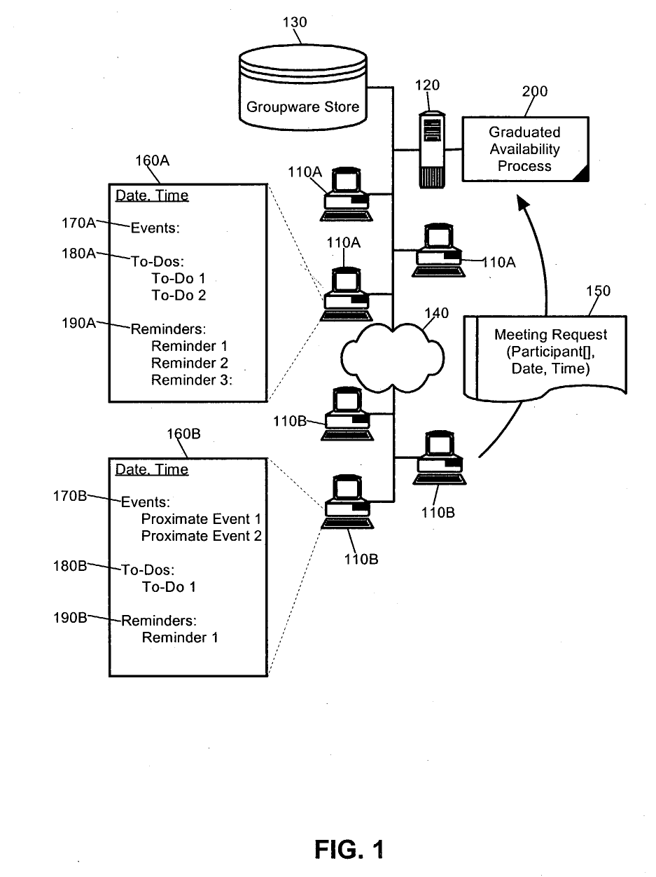

Notably, the method, system and apparatus of the present invention can have particular application to groupware systems in which meetings can be provisionally scheduled between different users in the groupware system. In this regard, FIG. 1 is a schematic illustration of an exemplary groupware system configured to process requests to schedule a meeting according to the graduated availability of the invited participants. The exemplary groupware system can include at least one groupware system server 120, a multiplicity of groupware clients 110A, 110B and at least one data store 130 of groupware data. Importantly, at least one of the groupware system servers 120 can be coupled to a graduated availability process 200.

Each of the groupware system servers 120, groupware clients 110A, 110B can be communicatively coupled to one another over a computer communications network. To that end, both local area networks and wide area networks, in addition to virtual private networks can be supported by way of a private Intranet, or global Internet 140. It will be recognized by one skilled in the art, however, that the invention is not so limited in consequence of the particular network architecture selected to host the groupware system of the present invention. Rather, the selection of architectures able to support the graduated availability process 200 can range from a standalone computing apparatus to a global network over which an application service provider (ASP) can process personal information management tasks for selected clients in the network.

In any case, in furtherance of illustrating by way of example the operation of the graduated availability process of the present invention, a client 110B can issue a request 150 for a meeting with one or more invited participants in the groupware system at a specified date and time. The graduated availability process 200 can reference in the groupware store 130 previously calendared tasks 160A, 160B for the invited participants to not only identify conflicting tasks which would prohibit the scheduling of the requested meeting, but also to identify the graduated availability of each of the invited participants for the specified data and time. In this regard, the graduated availability process 200 can consider not only previously scheduled meetings, but also previously scheduled events 170A, 170B other than meetings, to-dos 180A, 180B reminders 190A, 190B and the like.

In particular, the graduated availability process 200 can weight the scheduling of pre-existing tasks such as events 170A, 170B, to-dos 180A, 180B, and 190A, 190B according to pre-specified levels of importance relating to the impact of the types of tasks. More particularly, where some tasks are to be considered more likely to contribute to overloading than others, a greater weighting can be applied thereto. Notably, the weighting can change for non-conflicting tasks so as to account for the non-conflicting nature of the tasks. Moreover, the weighting can yet further change for tasks scheduled further outside of the specified time frame so as to indicate a lesser likelihood of those tasks contributing to the overloading of the invited participant.

In any case, each of the weightings can be averaged for each invited participant for the specified time frame. As an example, for an individual participant, on a scale of zero to one-hundred percent (0 . . . 1), where zero indicates no availability for the invited participant at the specified date and time, and where one indicates absolute availability for the invited participant at the specified data and time, each of the weighting can be a fractional portion of one so as to produce a fractional availability, such as sixty percent available, or thirty percent available depending upon the pre-specified tasks.

Subsequently, the averaged weightings, referred to hereafter as the graduated availability of the invited participant can be reported to the requesting client 110B. In consequence, the requesting client 110B can determine whether the specified date and time is likely to overload any one of the invited participants. Importantly, the process of determining the graduated availability of an invited participant can be repeated for each invited participant. As a result, an average of all computed graduated availabilities for all invited participants for the specified time and date, too, can be computed. In this way, where the requesting client 110B proposed multiple possible dates and times for the meeting, the particular date and time having the highest computed graduated availability can be selected, either manually or programmatically.

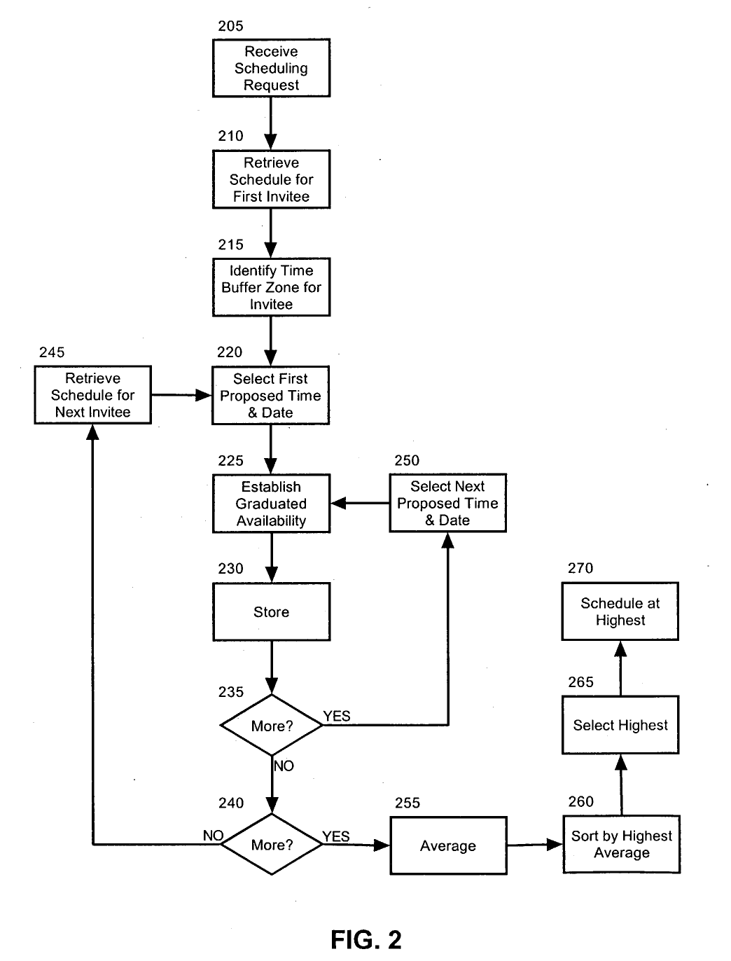

FIG. 2 is a flow chart illustrating a process for scheduling a meeting according to the graduated availability of the invited participants. Beginning in block 205, a scheduling request can be received. The scheduling request can include one more proposed dates and corresponding times during which a task can be scheduled for one or more specified participants for which the groupware system manages a coordinated calendar of tasks.

In block 210, the stored schedule for the first invited participant can be retrieved from groupware storage. In block 215, one or more buffer zones can be retrieved. The buffer zones can indicate a level of comfort for the invited participants in which an inordinate number of scheduled tasks, such as events, to-dos and reminders, can more likely overload the invited participants than would be the case were the tasks to be scheduled outside of the buffer zone. Though optional in nature, the buffer zones can provide progressively more comfortable zones from which it is less likely that contained tasks will adversely impact the invited participant's proposed scheduling of a new task in the specified time frame.

In any event, in block 220, the first time frame proposed by the received request can be selected and in block 225, the graduated availability for the selected time frame can be determined. For instance, first, it can be determined whether the selected time frame already includes a scheduled meeting. If so, the selected time frame can be assigned a graduated availability of one, indicating that not only has a task appeared during the selected time frame, but also that the task is a meeting which would preclude the concurrent scheduling of the proposed meeting. Hence, the task can be weighted one-hundred percent, thereby obviating the need to consider other scheduled tasks both within and outside of the specified time frame.

If a task does not directly conflict with the proposed meeting, however, other tasks scheduled during the specified time frame can be weighted and summed. Additionally, other tasks scheduled outside of the time frame, but within the buffer zone can be weighted, albeit more lightly than would be the case if the tasks were have to fallen within the specified time frame. Finally, to the extent that additional layers of buffer zones exist, additional tasks can be weighted within those buffer zones, recognizing, of course, that at some point tasks are to be weighted at zero and completely ignored as being too far outside of the specified time frame to matter.

Table 1 can be illustrative as an example of a graduated availability analysis for an invited participant about the specified date, Dec. 1, 2002 between the hours of 2:00 pm and 4:00 pm. In this exemplary circumstance, one buffer zone of twenty-four hours is presumed.

| Task | Date | Time | Duration | | Weight |
|---|---|---|---|---|---|
| Event | Dec. 02, 2002 | 7:30 am | 2 | hrs | 0.50 |
| (Meeting) | | | | | |
| To-Do | Dec. 01, 2002 | No Time | 20 | min | 0.10 |
| (Letter) | | | | | |
| To-Do | Dec. 01, 2002 | No Time | 1 | hr | 0.30 |
| (Doc Review) | | | | | |
| Reminder | Dec. 01, 2002 | No Time | 6 | min | 0.05 |
| (Event) | | | | | |
| Event | Nov. 28, 2002 | 5:00 pm | 1 | hr | 0.00 |
| (Meeting) | | | | | |
| Event | Dec. 01, 2002 | 9:00 am | 1 | Hr | 0.40 |
| (Doctors Appt) | | | 30 | min | |
| To-Do | Dec. 01, 2002 | 4:30 pm | 10 | min | 0.70 |
| (Phone Call) | | | | | |
| Graduated | Dec. 01, 2002 | 2:00 pm | 2 | hr | 0.34 |
| Availability | | | | | |

Consequently, the graduated availability for a meeting proposed for Dec. 1, 2002 between 2:00 pm and 4:00 pm can be computed to 34% as only six tasks fall within the buffer zone. Notably, in this exemplary circumstance it will be apparent that substantive tasks such as document review and phone calls falling within the buffer zone can be weighted more than non-substantive tasks such as reminders and the like. Moreover, tasks falling completely outside of the buffer zone can be ignored in their entirety.

In any case, returning now to FIG. 2, in block 230, the established graduated availability for the specified time frame can be stored and in decision block 235, it can be determined whether additional proposed time frames can be analyzed. If so, in block 250 the next proposed time and date can be selected and the process can be repeated through blocks 225 through 235. Otherwise, in decision block 240, it can be determined whether other invitees remain to be analyzed. If so, in block 245 the schedule for the next invitee can be retrieved and the process can repeat through blocks 220 through 240.

Once all schedules have been analyzed for all invited participants for all proposed time frames, in block 255, an average for all graduated availabilities for all invited participants for each proposed time frame can be computed. In block 260, the computed averages can be sorted from highest to lowest. In block 265, the highest graduated availability can be identified and the associated time frame also can be identified. Finally, in block 270, the proposed task can be scheduled at the associated time frame having the highest computed graduated availability for all invited participants. In this way, it is less likely that the proposed time frame for the task will give rise to an overload condition in one or more of the invited participants.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

I claim:

1. A method for scheduling a task based upon a measure of graduated availability for a specified time frame, the method comprising the steps of:
identifying tasks which previously had been scheduled about a specified time frame;
weighting each of said identified tasks according to a likelihood that a newly scheduled task when combined with said weighted identified tasks would interfere with completing said weighted identified tasks;
computing an average of said weights, said average producing a graduated availability for said specified time frame; and,
storing said graduated availability for use in scheduling a new task about said specified time frame.

2. The method of claim 1, further comprising the step of scheduling a new task about said specified time frame only if said stored graduated availability indicates that said new task would not interfere with completing said weighted identified tasks.

3. The method of claim 1, further comprising the step of scheduling a new task about said specified time frame only if said stored graduated availability indicates that said new task would interfere with completing said weighted identified tasks.

4. The method of claim 1, wherein said tasks comprise tasks selected from the group consisting of events, to-dos, and reminders.

5. The method of claim 1, further comprising the steps of:
establishing a buffer zone about said specified time frame; and,
performing said weighting step only for tasks identified as being scheduled within said buffer zone, while ignoring all other tasks scheduled outside both said specified time frame and said buffer zone when performing said computing step.

6. The method of claim 1, further comprising the steps of:
further identifying tasks scheduled during said specified time frame;
determining whether said further identified tasks directly conflict with said new task; and,
if it is determined that said new task would directly conflict with said further identified tasks, denying any request to schedule said new task during said specified time frame.

7. The method of claim 1, further comprising the steps of:
performing said identifying, weighting and computing steps for each of a set of specified time frames; and,
scheduling said new task about a selected one of said specified time frames which has a computed graduated availability indicating that said new task would least interfere with completing said weighted identified tasks when compared to computed graduated availabilities associated with others of said specified time frames.

8. The method of claim 1, further comprising the steps of:
performing said identifying, weighting and computing steps, for each of a set of invited participants in said new task, for each of a set of specified time frames; and,
computing an average of computed graduated availabilities for said invited participants for each one of said specified time frames; and,
scheduling said new task about a selected one of said specified time frames which has a computed average of computed graduated availabilities indicating that said new task would least likely interfere with completing said weighted identified tasks among said invited participants when compared to computed averages of other computed graduated availabilities associated with others of said specified time frames.

9. A groupware system comprising:
group calendering logic configured to schedule tasks for individual groupware users during specified time periods;
a data store coupled to said group calendaring logic for storing calendars managed by said group calendaring logic for each of said users; and,
a graduated availability processor coupled to said group calendaring logic and said data store, and programmed to determine whether scheduling a new task in at least one of said stored calendars involving selected ones of said users during a specified time frame would overload any one of said selected ones of said users by virtue of other tasks which had previously been scheduled in proximity to, but not in direct conflict with, said specified time frame.

10. The groupware system of claim 9, further comprising a store of pre-configured weights accessible by said graduated availability processor for each different type of task which can be scheduled by said group calendaring logic, said graduated availability processor applying said pre-configured weights when determining whether scheduling said new task would overload any one of said selected ones of said users.

11. The groupware system of claim 9, wherein said tasks comprise tasks selected from the group consisting of events, to-dos, and reminders.

12. A machine readable storage having stored thereon a computer program for scheduling a task based upon a measure of graduated availability for a specified time frame, the computer program comprising a routine set of instructions which when executed by the machine cause the machine to perform the steps of:
identifying tasks which previously had been scheduled about a specified time frame;
weighting each of said identified tasks according to a likelihood that a newly scheduled task when combined with said weighted identified tasks would interfere with completing said weighted identified tasks;
computing an average of said weights, said average producing a graduated availability for said specified time frame; and,
storing said graduated availability for use in scheduling a new task about said specified time frame.

13. The machine readable storage of claim 12, further comprising the step of scheduling a new task about said specified time frame only if said stored graduated availability indicates that said new task would not interfere with completing said weighted identified tasks.

14. The machine readable storage of claim 12, further comprising the step of scheduling a new task about said specified time frame only if said stored graduated availability indicates that said new task would interfere with completing said weighted identified tasks.

15. The machine readable storage of claim 12, wherein said tasks comprise tasks selected from the group consisting of events, to-dos, and reminders.

16. The machine readable storage of claim 12, further comprising the steps of:
establishing a buffer zone about said specified time frame; and,
performing said weighting step only for tasks identified as being scheduled within said buffer zone, while ignoring all other tasks scheduled outside both said specified time frame and said buffer zone when performing said computing step.

17. The machine readable storage of claim 12, further comprising the steps of:
further identifying tasks scheduled during said specified time frame;
determining whether said further identified tasks directly conflict with said new task; and,
if it is determined that said new task would directly conflict with said further identified tasks, denying any request to schedule said new task during said specified time frame.

18. The machine readable storage of claim 12, further comprising the steps of:
performing said identifying, weighting and computing steps for each of a set of specified time frames; and,
scheduling said new task about a selected one of said specified time frames which has a computed graduated availability indicating that said new task would least interfere with completing said weighted identified tasks when compared to computed graduated availabilities associated with others of said specified time frames.

19. The machine readable storage of claim 12, further comprising the steps of:
performing said identifying, weighting and computing steps, for each of a set of invited participants in said new task, for each of a set of specified time frames; and,
computing an average of computed graduated availabilities for said invited participants for each one of said specified time frames; and,
scheduling said new task about a selected one of said specified time frames which has a computed average of computed graduated availabilities indicating that said new task would least likely interfere with completing said weighted identified tasks among said invited participants when compared to computed averages of other computed graduated availabilities associated with others of said specified time frames.
